(19) United States
(12) Patent Application Publication
(10) Pub. No.: US 2010/0286878 A1
(43) Pub. Date: Nov. 11, 2010

(54) METHOD FOR COLD START PROTECTION OF A VEHICLE DRIVETRAIN

(76) Inventors: Anders Lindgren, Hisings Karra (SE); Erika Jakobsson, Goteborg (SE); Peter Templin, Vastra Frolunda (SE); Svante Karlsson, Vastra Frolunda (SE)

Correspondence Address: WRB-IP LLP, 801 N. Pitt Street, Suite 123, ALEXANDRIA, VA, 22314, US

(21) Appl. No.: 12/597,174

(22) PCT Filed: Apr. 23, 2007
(86) PCT No.: PCT/SE07/00394

§ 371 Date: Feb. 23, 2010

(51) Int. Cl. G06F 19/00

(52) U.S. Cl. 701/54

(57) ABSTRACT

A method for cold start protection of a vehicle drivetrain is provided. If temperature is below a certain predetermined temperature limit, which is lower than normal working temperature of an engine, then maximum allowable engine torque and/or maximum allowable engine rate of rotation is/are limited to define a limited drivetrain working area adapted to cold start sensitivity of at least one of the engine, and the transmission. Transmission control is automatically adapted to prevailing limited engine working area.

### BACKGROUND AND SUMMARY

The present invention relates to a method for cold start protection of a vehicle drivetrain. The invention also relates to a computer program and a computer program product for cold start protection of a vehicle drivetrain.

It is known that a cold start of a vehicle equipped with a combustion engine, as a prime mover, and an Automatic Mechanical Transmission (AMT) effects the hardware of the engine and AMT in a negative way, mainly due to the decreased lubrication performance of a lubricant in the vehicle when in a low temperature environment. There is a number of prior art solutions trying to milder the negative effects of decreased lubrication performance of the lubricant during a cold start.

One example is DE10325666, where the performance of gearshifts and different transmission commands are limited depending on temperature of the environment. To increase safety during a gear shift a decrease of the engine output torque is suggested.

Another example is that engines known in the art usually are equipped with functions that temporarily limit maximum allowable engine torque and/or engine rotational speed during cold start. When such an engine is connected to drive wheels of the vehicle via an AMT or other automatic transmission, this can give transmission control problems during cold start such as gear hunting and/or gear hanging due to unexpected cold start limited engine performance.

It is desirable to decrease the negative transmission control effects during a cold start.

The method according to an aspect of the invention is a method for cold start protection of a vehicle drivetrain. The vehicle comprises (includes, but is not necessarily limited to) at least an engine and an automatic transmission, where said engine is connected to vehicle drive wheels via said automatic transmission for achieving different gear ratios between the engine and the drive wheels, and where, —if temperature is below a certain predetermined temperature limit, which is lower than normal working temperature of said engine, at least one of the following two steps are executed;
maximum allowable torque produced by said engine is limited to a first predetermined torque value below maximum allowable engine torque for said normal working temperature, or
maximum allowable engine rate of rotation is limited to a first predetermined rotational speed value below maximum allowable rotational speed for said normal working temperature, and where said predetermined torque or rotational speed value defines a limited drivetrain working area being adapted to cold start sensitivity of at least one of said engine and said transmission. According to this method the problem of how to decrease the negative transmission control effects during a cold start is solved by adapting transmission control to at least one of said predetermined values as long as said temperature is below said predetermined temperature limit.

Hence, the advantage with the method according to the invention is better cold start transmission control which results in an increased overall drivetrain performance.

In a further embodiment of the invention gear selection and gear shift rotational speed are adapted to the limited drivetrain working area. Thus, shift points for both upshifts and downshifts can be adapted to prevailing engine working area limitations.

### BRIEF DESCRIPTION OF THE DRAWING

The present invention will be described in greater detail below with reference to the accompanying drawings which, for the purpose of exemplification, show further preferred embodiments of engine working area cold start limitations connected to the invention and also the technical background, and in which:

FIGS. 1 and 2 diagrammatically show engine torque/engine rotational speed diagrams of two engine working area cold start limitations.

FIG. 3 shows an apparatus 500 according to one embodiment of the invention.

### DETAILED DESCRIPTION

The present invention is with advantage applied in a vehicle equipped with an internal combustion engine, such as for example a coal hydrogen driven engine, as a propulsion unit. Usually, when the engine has been standing still for a while, the temperature of the engine is below a working temperature of the engine. The working temperature is the temperature at which different systefns of the engine works most efficiently, for example lubricating systems. Thus, a start of the engine at a temperature below the working temperature can be regarded as a cold start. A cold start can be defined to occur when the temperature is below a certain predetermined temperature, which temperature can be some degrees below said working temperature, and where said different systems of the engine are working sufficiently effective, so there is a minimal risk of increased wear or other cold start damage to the engine.

Preferably the engine is connected to driven wheels of the vehicle via a transmission for achieving different gear ratios between a rotational speed of the engine and rotational speed of the driven wheels. The engine and transmission can be defined as the drivetrain of the vehicle. To determine if a cold start condition is prevailing, the temperature can be measured via a sensor for measuring temperature. Said sensor can be arranged to measure temperature of a lubricant in a lubricating system of the engine and/or a cooling medium in a cooling system of the engine. In an alternative embodiment the temperature in the engine and the transmission can be measured. In a further embodiment only the temperature in the transmission can be measured to determine if a coldstart is prevailing. When the engine is started the temperature will increase due to the fuel combustion process in the engine. After a certain time, which depends on the prevailing conditions, the temperature in the drivetrain will reach the working temperature.

In a vehicle drivetrain comprising a transmission of the AMT-type, gear selections and gear shift decisions are made by a transmission control unit based on certain measured and/or calculated parameters such as vehicle speed, engine speed, rate of change of vehicle speed, rate of change of engine speed, throttle control position, rate of change of throttle control position, actuation of a vehicle braking system, currently engaged gear ratio etc. This is known from prior art. When the temperature has reached working temperature the whole performance range of the drivetrain can be used with minimal wear.

According to an embodiment a control unit (for example an engine control unit) in the vehicle can be programmed to measure if said temperature is below a predetermined temperature or not. If the temperature is above said predetermined temperature the whole performance range of the drivetrain is available for vehicle propulsion. If the temperature, on the other hand, is below said predetermined temperature the control unit is programmed to limit the performance of the drivetrain in such a way as to milder the effects of the coldstart when the temperature is below said predetermined temperature, and also according to the invention the transmission control unit is programmed to adapt transmission control as long as said temperature is below said predetermined temperature limit.

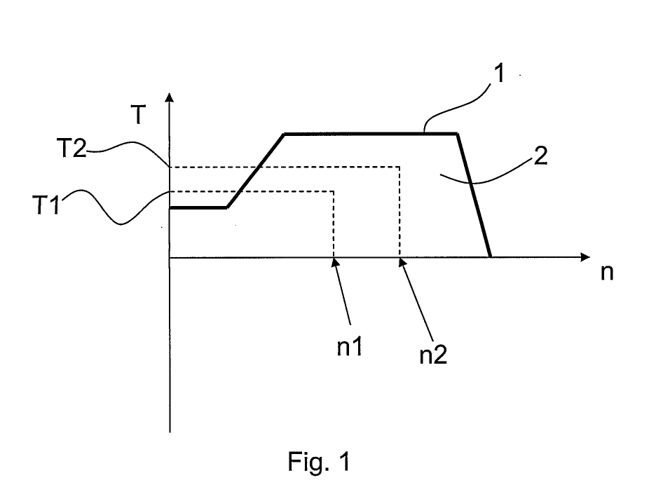

FIG. 1 shows a diagram with engine torque T on the y-axis and engine rotational speed n on the x-axis. The whole or maximum performance range of the engine is defined by curve 1, thus limiting the working area 2 of the engine. The form of the curve 1 is sketched schematically, but is in a whole at least essentially showing a typical torque/rotational speed curve for an combustion engine known in the art. According to this embodiment the performance of the drivetrain is limited in two stages depending on a first predetermined temperature ta and a second predetermined temperature tb. If the working temperature of the engine is tw, the relation between these temperatures is; ta″̂tb<tw.

Said second predetermined temperature limit tb can be only a few degrees below tw. If the temperature is below ta during a start of the engine maximum allowable rotational engine speed is limited to n1 and maximum allowable engine torque is limited to T1. Thus, an engine working area below these two values is defined. When the temperature has increased to a temperature above ta, but below tb, maximum allowable rotational engine speed is limited to n2 and maximum allowable engine torque is limited to T2. Thus, an extended working area defined by T2 and n2 is allowed when the temperature has increased to a value between ta and tb. There can also be embodiments with only one predetermined temperature limit defining only one more limited engine working area compared to the total working area defined by curve 1. There can also be embodiments with more than two predetermined temperatures, thus defining several allowable engine working areas. There can also be embodiments with a cold start working area limited only by a maximum allowable rotational engine speed, or there can be embodiments with a cold start working area limited only by a maximum allowable engine torque.

According an embodiment of the invention a transmission control unit for controlling gear selection and selection of gear shift rotational speed selects gears and shift speed in dependence of said limited engine working areas as discussed above, i.e. with limited maximum allowable rotational engine speed and/or limited maximum allowable engine torque. Thus, a gear selection and an upshift speed during a cold start will be adapted and different than normal when said method according to the invention is executed. The degree of transmission control adaptation is dependent on how much engine performance there is available. For example an engine performance limited according T1 and n1 in FIG. 1 gives an transmission control adaptation where for example an upshift is performed at an lower rotational speed than normal, due to the n1 limit, or an upshift is postponed, compared to normal, due to the n1 and T1 limits. Methods for adapting transmission control strategies as such to a certain available engine performance or engine working area are known in the art.

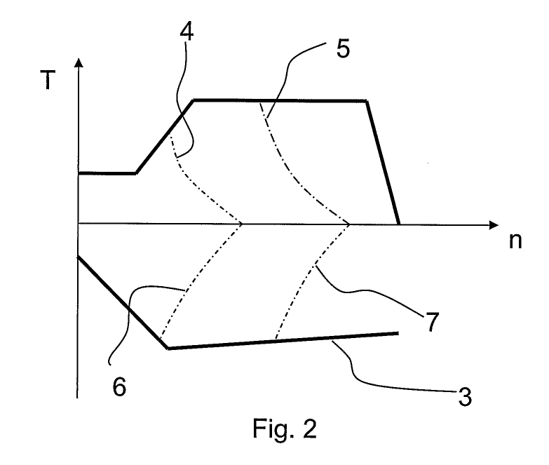

In FIG. 2 a corresponding curve defining the total engine working area as in FIG. 1 is also disclosed here. Additionally, a curve 3 is disclosed which defines maximum allowable negative engine torque and the engine working area for negative engine torques, during for example engine braking (auxiliary brake, which could e.g. be an engine compression brake). Here, the performance of the drivetrain is limited in two stages depending on a first predetermined temperature tx and a second predetermined temperature ty. If the working temperature of the engine is tW/the relation between these temperatures is, −tx<ty<Uw·

If the temperature is below tx during a start of the engine said maximum allowable rotational engine speed and maximum allowable engine torque is limited according to a first predetermined curve 4. For every predetermined maximum allowable engine rotational speed there is one value for maximum allowable engine torque. Thus, an engine working area below said predetermined first curve 4 is defined, where the maximum allowable torque and rotational speed values are more optimized compared to the embodiments explained through FIG. 1. When the temperature has increased to a temperature above tx, but below a predetermined second temperature ty, maximum allowable rotational engine speed is limited according to a second curve 5. Thus, an extended working area defined by curve 5 is allowed when the temperature has increased to a value between tx and ty. Preferably said curves 4 and 5 are formed so that a higher rotational speed allows a lower torque and vice versa. Thus, maximum allowable torque is continuously decreased along with increased rotational speed. This is due to that a relatively high engine torque is usually more damaging to the drivetrain when together with a higher rotational speed compared to a lower rotational speed for the same, torque. According to this embodiment disclosed in FIG. 2 there can also be two curves 6 and 7 for maximum allowable negative engine torques for the same predetermined temperatures tx and ty. The form of the curves 6 and 7 corresponds to the form of the curves 4 and 5, even though, they do not need to be an exact reflection of the curves 4 and 5, since corresponding negative torque at the same rotational speed as the positive torque can have a slightly different influence on the drivetrain.

According to one embodiment of the invention a transmission control unit for controlling gear selection and selection of gear shift rotational speed selects gears and shift speed in accordance with one of the limited engine working areas mentioned in FIG. 2 that is present during a cold start. Thus, a gear selection and a shift speed during a cold start will be adapted and different than normal when said method according to the invention is executed.

In a variant of the embodiment according to the invention shown through FIG. 2, only positive engine torque could be limited during coldstart, thus transmission control is according to the invention only adapted to curves 4 and/or 5 in FIG. 2. In another variant of the embodiment according to the invention transmission control can be adapted only to negative engine torque curves 6 and/or 7 shown in FIG. 2.

In a further embodiment engine torque could be limited during coldstart according to a curve or curves similar to the one showed in FIG. 2 and negative torque could be limited during cold start according to a maximum allowable rotational engine speed to and a maximum allowable engine torque in a corresponding way, but for negative torque, as shown in FIG. 1. And according to the invention for all above mentioned limited engine working areas transmission control can be adapted to the prevailing cold start limited engine performance. Thus, gears and shift speeds can be selected in dependence of said limited engine working areas as mentioned in FIG. 2, i.e. with limited maximum allowable rotational engine speed and/or limited maximum allowable engine torque. A gear selection and an upshift/downshift speed will be different than normal when said method according to the invention is executed.

If the gear ratio shift is a downshift, then the transmission control unit is programmed to postpone the downshift until a vehicle condition occurs when the engine rate of rotation is expected to be slightly below said maximum allowable cold start rotational speed with said lower gear engaged. Further, If the gear ratio shift is a downshift, then the transmission control unit can be programmed to select a semi low gear which after the downshift and with current vehicle condition gives an engine rate of rotation slightly below said maximum allowable cold start rotational speed.

There can also be limited working areas according to FIG. 2 with only one or more than two predetermined temperatures, thus defining only one or more than two allowable engine working areas, according to which a transmission control unit according to the invention is programmed to automatically being adapted to.

Also the embodiment disclosed through FIG. 1 can be developed to include negative engine torques with predetermined temperature limits and thereto connected maximum allowable engine rotational speed limits and negative engine torques.

The control of the torque produced by the engine and the engine rotational speed is done in a known way, for example engine torque and rotational speed can be controlled via fuel control. Said different engine controlling as such are known in the art.

The different predetermined temperatures and rotational engine speeds and engine torques connected thereto can be provided through testing of a specific drivetrain configuration. Thus, different engine models and/or transmissions gives different preferable limits for coldstart to decrease the negative effects of coldstarts in the best possible way.

In an further embodiment of the invention said transmission control unit can be programmed to, under certain vehicle conditions, overrule the prevailing cold start engine working area limitations. For example, in order to avoid possible vehicle stop during gearshift in a steep uphill the transmission control unit can be allowed to overrule prevailing limited engine working area limitation by allowing the engine temporarily to work within the whole (or normal) possible engine working area.

Said transmission can be of different types, for example; a continuously variable transmission (CVT), a step geared transmission such as a power shift transmission (e.g. a dual clutch transmission), an automatic transmission or an automated mechanical transmission (AMT), et cetera.

The information regarding different limited engine working areas can be transmitted to the transmission control unit via for example a can-bus system in the vehicle. Thus, the transmission control unit can continuously be updated on available engine performance.

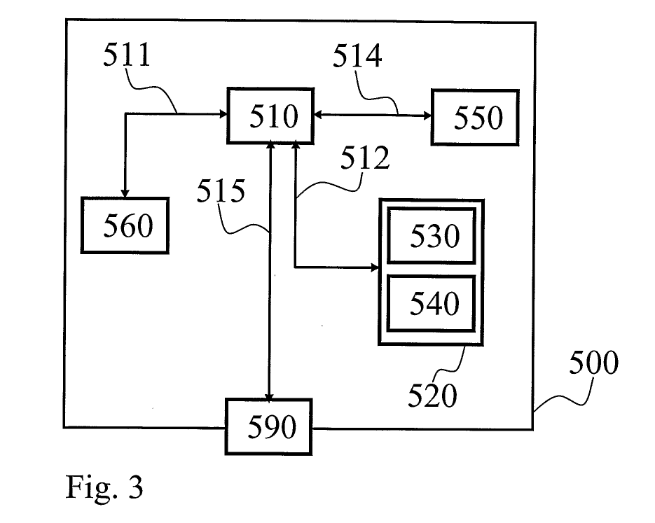

FIG. 3 shows an apparatus 500 according to one embodiment of the invention, comprising a nonvolatile memory 520, a processor 510 and a read and write memory 560. The memory 520 has a first memory part 530, in which a computer program for controlling the apparatus 500 is stored. The computer program in the memory part 530 for controlling the apparatus 500 can be an operating system.

The apparatus 500 can be enclosed in, for example, a control unit, such as the above mentioned transmission control unit. The data-processing unit 510 can comprise, for example, a microcomputer.

The memory 520 also has a second memory part 540, in which a program for controlling the transmission during a coldstart according to the invention is stored. In an alternative embodiment, the program for controlling the transmission during a coldstart is stored in a separate nonvolatile data storage medium 550, such as, for example, a CD or an exchangeable semiconductor memory. The program can be stored in an executable form or in a compressed state.

When it is stated below that the data-processing unit 510 runs a specific function, it should be clear that the data-processing unit 510 is running a specific part of the program stored in the memory 540 or a specific part of the program stored in the nonvolatile recording medium 550.

The data-processing unit 510 is tailored for communication with the memory 550 through a data bus 514. The data-processing unit 510 is also tailored for communication with the memory 520 through a data bus 512. In addition, the data-processing unit 510 is tailored for communication with the memory 560 through a data bus 511. The data-processing unit 510 is also tailored for communication with a data port 590 by the use of a data bus 515.

The method according to the present invention can be executed by the data-processing unit 510, by the data-processing unit 510 running the program stored in the memory 540 or the program stored in the nonvolatile recording medium 550.

The invention should not be deemed to be limited to the embodiments described above, but rather a number of further variants and modifications are conceivable within the scope of the following patent claims.

1. A method for cold start protection of a vehicle drivetrain, comprising at least an engine and an automatic transmission, where the engine is connected to vehicle drive wheels via the automatic transmission for achieving different gear ratios between the engine and the drive wheels, and where, if temperature is below a certain predetermined temperature limit, which is lower than normal working temperature of the engine, at least one following two steps are executed;
limiting maximum allowable torque produced by the engine to a first predetermined torque value below maximum allowable engine torque for the normal working temperature, or
limiting maximum allowable engine rate of rotation to a first predetermined rotational speed value below maximum allowable rotational speed for the normal working temperature,
and where the predetermined torque or rotational speed value defines a limited drivetrain working area being adapted to cold start sensitivity of at least one of the engine and the transmission, wherein transmission control is adapted to at least one of the predetermined values as long as the temperature is below the predetermined temperature limit.

2. A method as in claim 1, wherein gear selection and gear shift rotational speed are adapted to the limited drivetrain working area.

3. A method as in claim 2, where the first predetermined rotational speed value and the first predetermined torque value both are used for cold start protection and that their intersection in a torque/rotational speed diagram for the engine together correspond to a dot of intersection, wherein several dots of intersection in the diagram correspond to other predetermined values of maximum allowable cold start torque and maximum allowable cold start rotational speed, and where the several dots define a curve, the curve defining a limited engine working area being adapted to cold start sensitivity of at least one of the engine and the transmission.

4. A method as in claim 1, wherein the predetermined values of maximum allowable cold start torque are maximum allowable positive engine torques for different engine rotational speed values.

5. A method as in claim 1, wherein the predetermined values of maximum allowable cold start torque are maximum allowable negative engine torques for different engine rotational speed values.

6. A method as in claim 1, where the automatic transmission is a step geared transmission, characterized in the gear selection when executed being an upshift or a downshift.

7. A method as in claim 6, wherein when the gear ratio shift being a downshift to a lower gear, the downshift is postponed until a vehicle condition occurs when the engine rate of rotation is expected to be slightly below the maximum allowable cold start rotational speed with the lower gear engaged.

8. A method as in claim 6, wherein when the gear ratio shift being a downshift a semi low gear is selected which after the downshift and with current vehicle condition gives an engine rate of rotation slightly below the maximum allowable cold start rotational speed.

9. A method as in claim 3, wherein the higher maximum allowable cold start torque value the lower is the maximum allowable cold start rotational speed value.

10. A method as in claim 1, wherein the temperature being a temperature of a lubricant in the engine.

11. A method as in claim 1, wherein the temperature being a temperature of a cooling medium in the engine.

12. A method as in claim 1, wherein under certain vehicle conditions the cold start engine working area limitation is temporarily overruled in order to secure vehicle traveling advancement.

13. A computer readable medium comprising a computer program comprising a program code for executing the method as claimed in claim 1 the.

14. A computer program product comprising a program code, stored on a computer-readable medium, for executing the method as claimed in claim 1 the.

15. A computer program product directly loadable into an internal memory in a computer, which computer program product comprises a computer program for executing the method as claimed in claim 1 the.
